(19) United States
(12) Patent Application Publication
(10) Pub. No.: US 2025/0277714 A1
(43) Pub. Date: Sep. 4, 2025

(54) A HANG-OFF SYSTEM FOR MEASURING A TOP TENSION IN A FLEXIBLE PIPE, ASSOCIATED ASSEMBLY AND ASSEMBLING METHOD

(71) Applicant: TechnipFMC Subsea France, COURBEVOIE (FR)

(72) Inventors: Cristiano ALVES PINTO MOSQUEIRA GOMES, OSLO (SKØYEN) (NO); Camila Pereira ALVARÃES, Copacabana, RIO DE JANEIRO (BR); Carlos Filipe CARDOSO BANDEIRA, Vila Isabel, RIO DE JANEIRO (BR); Carlos RONALDO ANDRADE DOS REIS, Jacarepagua, RIO DE JANEIRO (BR); Fábio Rogerio ARRUDA, RIO DE JANEIRO (BR); Fernando LEITÃO GONÇALVES TOSTE, Tijuca, RIO DE JANEIRO (BR); Jucimar MOZA, RIO DE JANEIRO (BR); Paulo Bailly MAGALHES, Icaraí NITERÓI (BR)

(21) Appl. No.: 18/862,522

(22) PCT Filed: May 4, 2023
(86) PCT No.: PCT/EP2023/061742

§ 371 Date: Nov. 1, 2024

(30) Foreign Application Priority Data
May 5, 2022 (EP) 22305669.8

(51) Int. Cl. G01L 5/10; E21B 19/00

(52) U.S. Cl. CPC G01L 5/10; E21B 19/004

(57) ABSTRACT

A hang-off system (16) for measuring a top tension in a flexible pipe (12), the hang-off system (16) that includes:
an annular collar (66) intended to be arranged around a top end-fitting (26) of a flexible pipe, the annular collar (66) being formed by at least two parts assembled to each other, each part comprising a top plate (82) and a bottom plate (84) assembled to each other, said top plate (82) and bottom plate (84) delimiting an intermediate space (86) between them, at least one part comprising at least one load cell (88) arranged in the intermediate space (86) and sandwiched between the top plate (82) and the bottom plate (84), the bottom plate (84) being intended to be assembled on a surface assembly,
a data acquisition system (68) connected to the load cell (86).

According to a first aspect, the present invention relates to a hang-off system for measuring a top tension in a flexible pipe.

The flexible pipe is used to transport production fluids, such as oil and/or gas and/or water from one location to another. The flexible pipe is generally formed of a plurality of layers that are concentric and superposed. The flexible pipe is for example a flexible pipe of a type that is not bonded (or “unbounded”). It is considered “unbounded” since the tensile armor layers of the pipe are free to move relative to each other during a flexion of the flexible pipe, i.e. the tensile armor layers are not embedded in a bonding material such as an elastomer.

In particular, the flexible pipe is a flexible pipe disposed across a body of water, between a bottom assembly designed for collecting a fluid at the bottom of the body of water, and a surface assembly designed for collecting and distributing the fluid. The surface assembly may be a semi-submersible platform, a floating production storage and offloading unit (FPSO), a ship, or any other floating unit such as a ship.

The flexible pipe is generally formed by an assembly of a flexible pipe body and at least one end fitting arranged at an end of the flexible pipe body. The end fitting provides a mechanical device forming a transition between the flexible pipe and a connector. Various layers of the flexible pipe are introduced to the end fitting and are sealingly engaged with a portion of the end fitting.

Generally, a hang-off system is provided to assemble the flexible pipe onto the surface assembly. The hang-off system allows transferring the vertical loads from the flexible pipe to the surface assembly. In particular, the hang-off system holds the end fitting in place in case of reaction due to an abrupt rupture of the flexible pipe top section.

Indeed, in use, the end fitting of the flexible pipe is subject to various forces including high tension and compression loads due to environmental factors such as temperature and pressure fluctuations and/or underwater currents. Moreover, the weight of the flexible pipe may also cause high stresses and strains in the end fitting. Through the lifetime of the flexible pipe, these forces may lead to structural failures of the flexible pipe, if used outside the design conditions and qualification envelope, or possible failure modes depending on the operational conditions.

It is then crucial to monitor forces acting on the top section of the flexible pipe over time to allow appropriate servicing when needed.

An object of the invention is to provide a hang-off system fulfilling the requirements in term of structural resistance and allowing a reliable monitoring of the deformation of the top section of the flexible pipe and an easy installation on the surface assembly.

To the end, the subject-matter of the invention relates to a hang-off system for measuring a top tension in a flexible pipe, said flexible pipe comprising a flexible pipe body and a top end-fitting arranged at an end of the flexible pipe body, the hang-off system being intended to maintain the top end-fitting on a surface assembly, the hang-off system comprising:
an annular collar extending along a first axis, the annular collar being intended to be arranged around the top end-fitting, the annular collar being formed by at least two parts assembled to each other, each part comprising a top plate and a bottom plate assembled to each other, said top plate and bottom plate delimiting an intermediate space between them, at least one part comprising at least one load cell arranged in the intermediate space (86) and sandwiched between the top plate and the bottom plate, the bottom plate being intended to be assembled on the surface assembly,
a data acquisition system connected to the load cell.

The hang-off system according to the invention may comprise one or more of the following features, taken into consideration in isolation, or in accordance with any technically possible combinations:
each part comprises at least one load cell, the load cells of the hang-off system being regularly spaced around the first axis;
the top plate mainly extends in a first plane and the bottom plate mainly extends in a second plane substantially parallel to the first plane and perpendicular to the first axis;
the annular collar is formed by exactly two parts or exactly three parts assembled to each other;
the annular collar is formed by exactly three parts assembled to each other, each part comprising a single load cell sandwiched between the top plate and the bottom plate of said part;
each part comprises a plurality of fasteners and locknuts for assembling the top plate to the bottom plate, each fastener extending along an axis substantially parallel to the first axis;
the top plate and/or the bottom plate define a convex surface protruding towards the intermediate space, said convex surface being in contact with the load cell;
each bottom plate and each top plate of each part of the annular collar extends respectively along a circular arc in a plane substantially perpendicular to the first axis between a first end and a second end, each first end and second end comprising at least an assembling portion, the at least two parts of the annular collar being assembled to each other by said assembling portions;
at least one part of the annular collar comprises at least one shim arranged between the bottom plate and the load cell; and
each part of the annular collar comprises at least a first reinforcement element protruding from the top plate towards the intermediate space, and a second reinforcement element protruding from the bottom plate towards the intermediate space, the first reinforcement element being arranged facing the second reinforcement element along a direction substantially parallel to the first axis, the first reinforcement element and the second reinforcement element being separated by a gap comprised between 5 mm and 10 mm.

The subject-matter of the invention also relates to an assembly comprising:
a flexible pipe comprising a top end-fitting,
a surface assembly,
a hang-off system as described above, the hang-off system maintaining the top end-fitting on the surface assembly.

The subject-matter of the invention also relates to a method for assembling a top end-fitting of a flexible pipe on a surface assembly with a hang-off system as described above, said method comprising the following steps:
a preparation step comprising, for each part of the annular collar, assembling the top plate to the bottom plate and arranging at least one load cell in the intermediate space of one of the parts,
an assembling step comprising forming the annular collar by assembling the parts to each other around the end fitting and by assembling the parts to the surface assembly.

The method according to the invention may comprise one or more of the following features, taken into consideration in isolation, or in accordance with any technically possible combinations:
the preparation step is performed onshore and the assembling step is performed offshore;
the preparation step comprises a factory acceptance test and/or a site acceptance test and/or a calibration test; and
the preparation test comprises pre-assembling the parts of the annular collar to each other before performing the factory acceptance test and/or the site acceptance test and/or the calibration test, and disassembling the parts from each other after the factory acceptance test and/or the site acceptance test and/or the calibration test are completed.

The invention will be better understood upon reading the description which will follow, given solely by way of example, and with reference being made to the accompanying drawings in which:

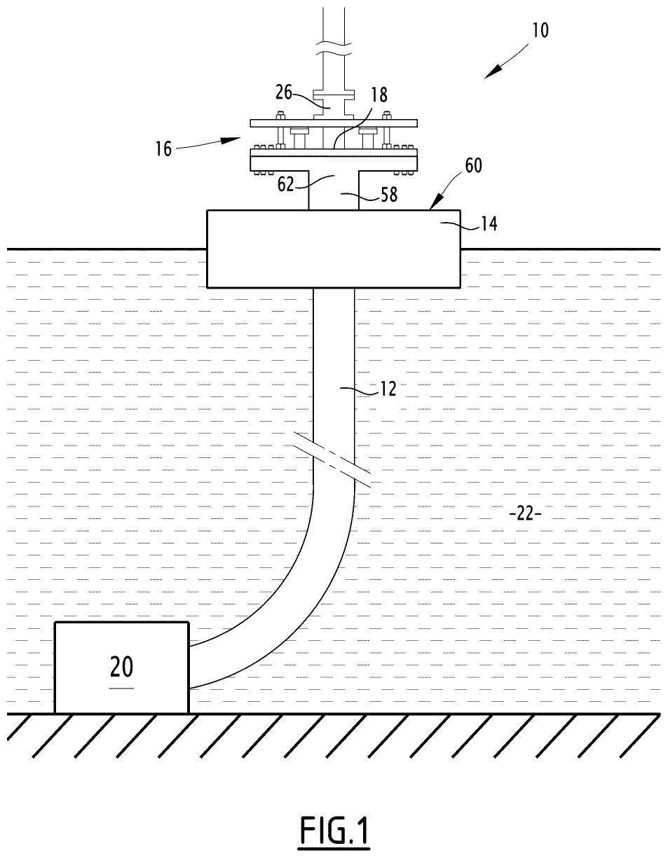

FIG. 1 is a schematic view of an assembly according to a first embodiment of the invention,

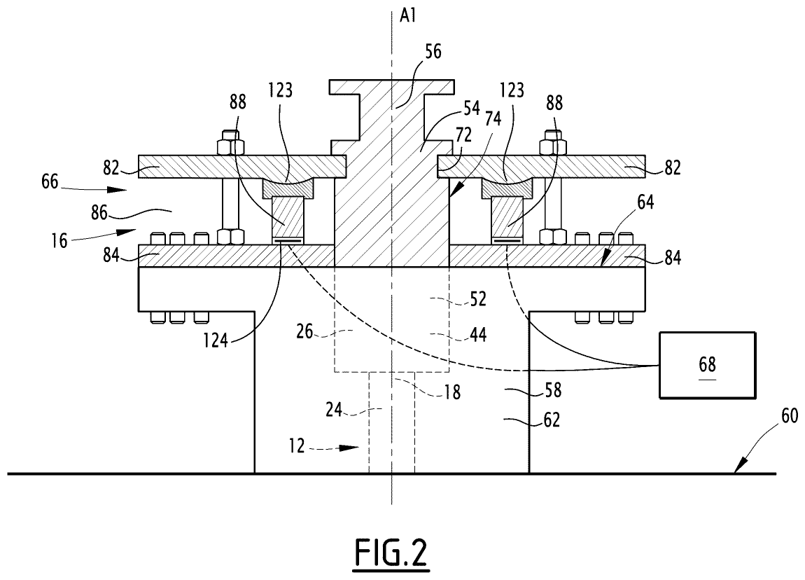

FIG. 2 is a schematic radial section of a the hang-off system of the assembly of FIG. 1,

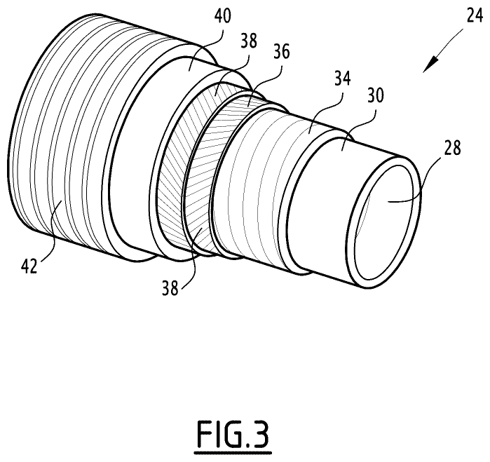

FIG. 3 is a partially stripped down perspective view of a section of a flexible pipe,

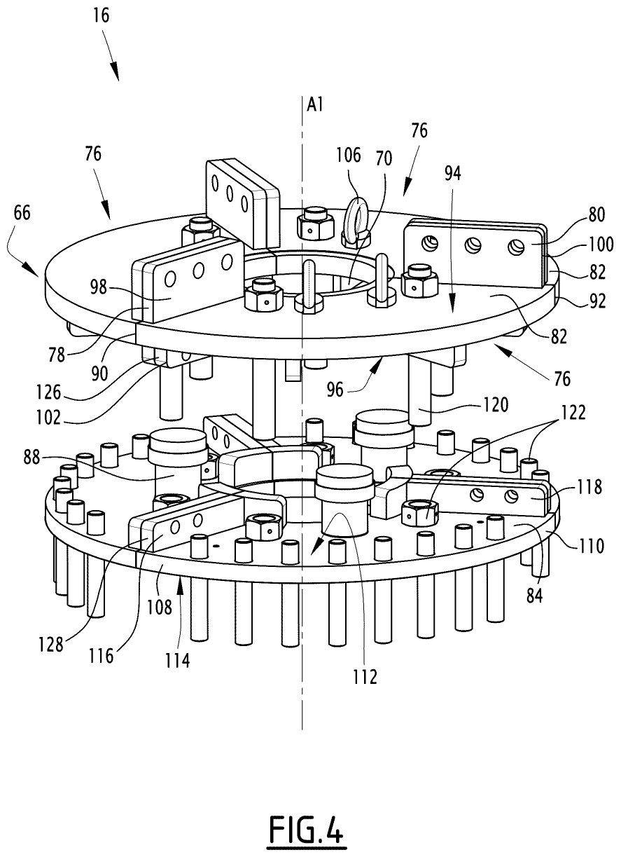

FIG. 4 is a perspective exploded view of the hang-off system of FIG. 1,

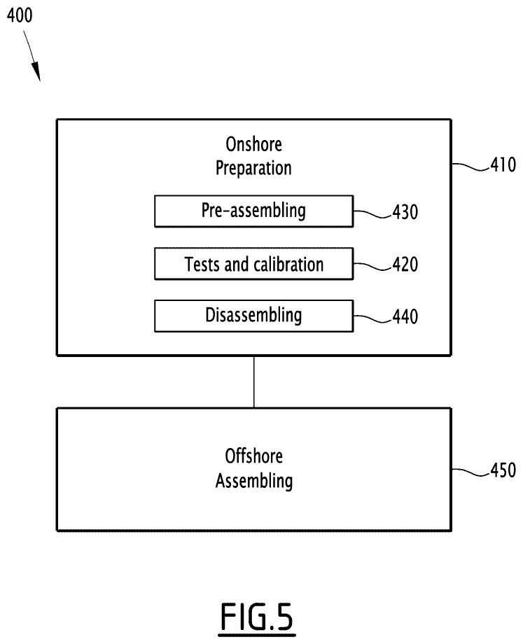

FIG. 5 is a schematic flowchart of a method for assembling according to the invention, and

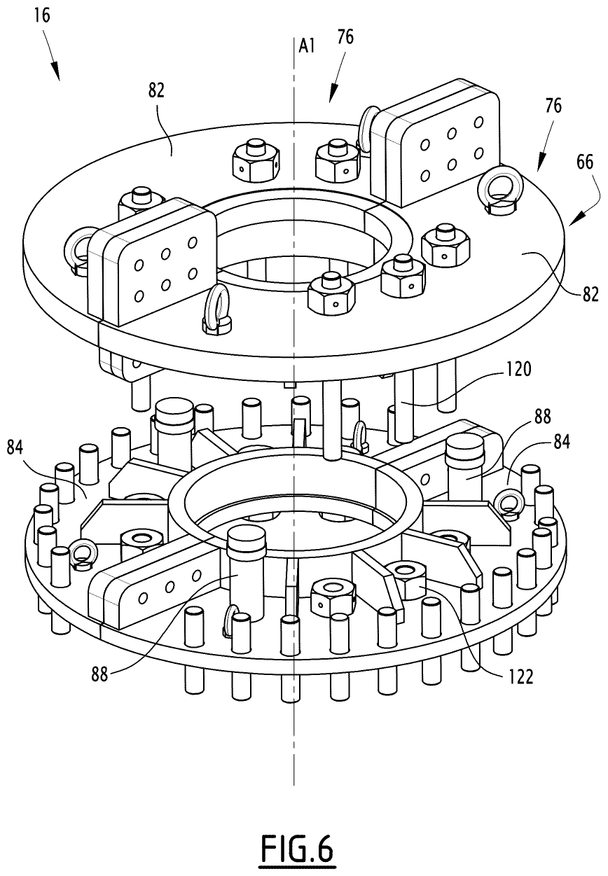

FIG. 6 is a perspective exploded view of a hang-off system according to a second embodiment of the invention.

An assembly 10 according to the invention is shown in FIGS. 1 and 2. The assembly 10 comprises a flexible pipe 12, a surface assembly 14 and a hang-off system 16 for maintaining an end 18 of the flexible pipe 12 on the surface assembly 14. In the example of FIG. 1, the assembly 10 further comprises a bottom assembly 20 submerged in a body of water 22.

The flexible pipe 12 is used to transport production fluids, such as oil and/or gas and/or water from one location to another. The flexible pipe 12, also referred as a riser, is intended to transport fluids from the bottom assembly 20 to the surface assembly 14.

The flexible pipe 12 comprises a flexible pipe body 24 and one or more end fittings 26 along its length. An example of a flexible pipe body 24 is shown in FIG. 3. The flexible pipe 12 comprises a top end fitting 26 maintained on the surface assembly 14 by the hang-off system 16.

As shown in FIG. 3, the flexible pipe body 24 is formed by a combination of layered materials delimiting a central passage 28 for circulation of fluids. For example, the flexible pipe body 24 comprises metallic layers, polymeric layers, composite layers, or a combination of different materials.

The flexible pipe body 24 comprises a pressure sheath 30 and an optional innermost carcass layer positioned inside the pressure sheath 30.

The carcass layer is used to prevent collapse of the pressure sheath 30 due to pipe decompression, external pressure, and tensile armor pressure and mechanical crushing loads. The carcass layer is for example a metallic layer, formed from stainless steel. The carcass layer may also be formed from composite, polymer or other material, or a combination of materials. Flexible pipe bodies 24 may be used without a carcass layer and are referred as smooth bore. Alternatively, pipe bodies may be used with a carcass layer and are referred as rough bore.

The pressure sheath 30 acts as a fluid retaining layer and comprises a polymer layer ensuring internal fluid integrity. The pressure sheath 30 may comprise itself several sub-layers.

The flexible pipe body 24 may comprise an optional pressure armor layer 34 around the pressure sheath 30. The pressure armor layer 34 is a structural layer that increases the resistance of the flexible pipe 12 to internal and external pressures. The pressure armor layer 34 is for example made of metal, such carbon steel. The pressure armor layer 34 is for example made of a round or profiled wires helically wound along the length of the flexible pipe body 24 at a lay angle typically between about 55° to 90°. The profiled wires are preferably interlocked. The pressure armor layer 34 may also be formed from composite, or other material, or a combination of materials.

The flexible pipe body 24 may comprise an optional first tensile armor layer 36 and an optional second tensile armor layer 38. Each tensile armor layer 36, 38 is used to sustain tensile loads and internal pressure. The tensile armor layers 36, 38 are generally formed by a plurality of metallic wires helically wound along the length of the flexible pipe body 24 at a lay angle typically between about 10° to 55°. The tensile armor layers 36, 38 are often counter-wound in pairs. The tensile armor layers 36, 38 are for example metallic layers. They could also be formed from composite, polymer or a combination of materials.

The flexible pipe body 24 also typically comprises optional layers of abrasion-resistant or anti-wear and insulation and an outer sheath 40 surrounded the inner layers. A carcass 42 may be disposed externally to the outer sheath 40. Said layers comprises a polymer layer used to protect the pipe against penetration of seawater, corrosion, abrasion and mechanical damage.

The end fitting 26 is located at one end 18 of the flexible pipe body 24. The end fitting 26 extends along a first axis A1. The end fitting 26 comprises and end fitting body 44 delimiting an internal bore running along the first axis A1, and a casing assembled to the end fitting body 44, for example through bolts or other securing members.

The casing is sealed to the flexible pipe body 24 and in particular to the outer sheath 40 of the flexible pipe body 24.

The end fitting body 44 extends from a first end 52 delimiting an open-mouth region receiving an end 18 of the flexible pipe body 24, to a second end 54, forming a connector 56.

The connector 56 is a substantially disk-liked flared region. The connector 56 may be connected to a matching connector of a further end fitting body of an adjacent flexible pipe, or to a pipe of the surface assembly 14.

In the example of FIG. 1, the flexible pipe 12 is disposed across the body of water 22, between the bottom assembly 20 designed for collecting a fluid at the bottom of the body of water 22, and the surface assembly 14 designed for collecting and distributing the fluid. The surface assembly 14 may be a semi-submersible platform, a floating production storage and offloading unit (FPSO), a ship, or any other floating unit such as a ship.

The hang-off system 16 is provided to maintain the flexible pipe 12 onto the surface assembly 14. The hang-off system 16 allows transferring the vertical loads from the flexible pipe 14 to the surface assembly 14. In particular, the hang-off system 16 holds the end fitting 26 in place onto the surface assembly 14 in case of reaction due to an abrupt rupture of the flexible pipe 12.

In the example of FIGS. 1 and 2, the surface assembly 14 comprises a support 58 projecting from a surface 60 of the surface assembly 14. The support 58 is for example a cylindrical tube 62, referred in the prior art as “I-Tube”, protruding from the surface 60 of the surface assembly 14 according to the first axis A1 substantially perpendicular to the surface 60. The support 58 delimits a conduit in communication with the body of water 22 and allowing the passage of the flexible pipe 12. The support 58 comprises a top annular surface 64 connected to the hang-off system 16. Preferably, the top annular surface 64 defines a plurality of holes receiving fasteners for assembling the hang-off system 16 to the support 58.

According to the invention, the hang-off system 16 comprises an annular collar 66 extending along the first axis A1, and a data acquisition system 68.

As schematically shown in FIGS. 2 and 4, the annular collar 66 delimits a central passage 70 receiving the flexible pipe 12, and in particular the end fitting 26 of the flexible pipe 12. The annular collar 66 is arranged around the top end fitting 26 of the flexible pipe 12. The annular collar 66 entirely surrounds the end fitting 26. Preferably, the annular collar 66 mechanically cooperates with an annular grove 72 defined in the side wall 74 of the end fitting 26. The annular collar 66 is fixed above the support 58 of the surface assembly 14 in contact with the top annular surface 64 and fixed to the support 58 with a plurality of fixation members.

According to the invention, the annular collar 66 is formed by at least two parts 76 assembled to each other. Each part 76 surrounds a portion, in particular an angular portion, of the side wall 74 of the end fitting 26 around the first axis A1.

In the first embodiment, the annular collar 66 comprises exactly three parts 76 assembled to each other to form the annular collar 66. Each part 76 of the annular collar 66 extends along a circular arc in a plane substantially perpendicular to the first axis A1 between a first end 78 and a second end 80, around the end fitting 26. In the first embodiment, the circular arc has an angle substantially equal to 120°.

According to the invention, each part 76 comprises a top plate 82 and a bottom plate 84 assembled to the top plate 82. The top plate 82 and the bottom plate 84 delimit an intermediate space 86 between them. At least one part 76 comprises at least one load cell 88 arranged in the intermediate space 86 and sandwiched between the top plate 82 and the bottom plate 84.

The top plate 82 is arranged above the bottom plate 84 according to the first axis A1. The top plate 82 extends in a first plane substantially perpendicular to the first axis A1. The top plate 82 extends along a circular arc in the first plane between a first end 90 and a second end 92. In the first embodiment, the circular arc has an angle substantially equal to 120°. The top plate 82 defines a top surface 94 and a bottom surface 96 arranged opposite the top surface 94. The top surface 94 is oriented towards the connector 56. The bottom surface 96 is oriented towards the intermediate space 86. The top surface 94 and the bottom surface 96 are substantially parallel to each other.

Preferably, the top plate 82 comprises at least a first upper assembling portion 98 located at the first end 90 and a second upper assembling portion 100 located at the second end 92. For example, the first upper assembling portion 98 and the second upper assembling portion 100 protrude from the top surface 94 of the top plate 82 opposite the intermediate space 86. Preferably, the first upper assembling portion 98 and the second upper assembling portion 100 extend in respective radial planes relative to the first axis A1. In addition or alternatively, the top plate 82 comprises at least a first lower assembling portion 102 located at the first end 78 and a second lower assembling portion located at the second end 80. For example, the first lower assembling portion 102 and the second lower assembling portion protrude from the bottom surface 96 of the top plate 82 towards the intermediate space 86. Preferably, the first lower assembling portion 102 and the second lower assembling portion extend in respective radial planes relative to the first axis A1. Preferably, the first upper assembling portion 98 and the first lower assembling portion 102 extend in the same radial plane. Preferably, the second upper assembling portion 100 and the second lower assembling portion extend in the same radial plane.

The top plates 82 of the parts 76 of the annular collar 66 are assembled to each other through the first upper and/or lower assembling portions 98, 102 and the second upper and/or lower assembling portions 100. For example, the assembling portions 98, 102, 100 of the parts 76 are bolted to each other.

The top plate 82 may also comprise lifting members 106, such as lifting hooks, protruding from the top surface 94 of the top plate 82 to ease the handling of the hang-off system 16 with a hoisting device (not shown).

The bottom plate 84 is arranged below the top plate 82 according to the first axis A1. The bottom plate 84 extends in a second plane substantially perpendicular to the first axis A1 and substantially parallel to the first plane. The bottom plate 84 extends facing the top plate 82. The bottom plate 84 extends along a circular arc in the second plane between a first end 108 and a second end 110. In the first embodiment, the circular arc has an angle substantially equal to 120°. The bottom plate 84 defines a top surface 112 and a bottom surface 114 arranged opposite the top surface 112. The top surface 112 is oriented towards the intermediate space 86. The bottom surface 114 is oriented towards the support 58. The top surface and the bottom surface are substantially parallel to each other.

Preferably, the bottom plate 84 comprises at least a first upper assembling portion 116 located at the first end 108 and a second upper assembling portion 118 located at the second end 110. For example, the first upper assembling portion 116 and the second upper assembling portion 118 protrude from the top surface 112 of the bottom plate 84 towards the intermediate space 86. Preferably, the first upper assembling portion 116 and the second upper assembling portion 118 extend in respective radial planes relative to the first axis.

The bottom plates 84 of the parts 76 of the annular collar 66 are assembled to each other through the first upper assembling portions 116 and the second upper assembling portions 118. For example, the assembling portions 116, 118 of the parts 76 are bolted to each other.

The bottom plate 84 is preferably bolted to the support 58 and in particular to the top annular surface 64 of the support 58.

Advantageously, each part 76 comprises at least one fastener 120, preferably two fasteners 120, and associated locknuts 122 to assemble the top plate 82 and the bottom plate 84 to each other. Each fastener 120 extends through the intermediate space 86 along an axis substantially parallel to the first axis A1. For example, the fasteners 120 are regularly distributed angularly around the first axis A1. In addition, the fasteners 120 may be arranged along a plurality of radial directions relative to the first axis A1.

The fasteners 120 and the locknuts 122 are critical for the hang-off system 16 since they allow controlling the alignment of the top plate 82 with respect to the bottom plate 84. As it will be described in details later, they allow the creation of an independent measurement module formed by a part 76 of the annular collar 66 avoiding any kind of loose parts and complex assembly during the offshore installation. The fasteners 120 and locknuts 122 allow a proper preparation of each part 76 of the annular collar 66 avoiding inaccurate and unequal tightening effect from one part 76 to another one. This improve the reliability and the accuracy of the measurements performed with the hang-off system 16. Each part 76 is pre-assembled with its top plate 82 and bottom plate 84 onshore after factory acceptance test. The fasteners 120 and the locknuts 122 ensure that the hang-off system 16 is assembled offshore, using the same parts in the same place. This improves the traceability. The fasteners 120 and the locknuts 122 also have a key role regarding the structural integrity. The fasteners 120 and the locknuts 122 allow fulfilling the requirements to resist explosion, i.e, unpredicted and abnormal force applied in the upward direction. The fasteners 120 and the locknuts 122 do not allow lateral or angular movements between the top plate 82 and the bottom plate 84.

Preferably, each part 76 comprises at least one load cell 88 arranged in the intermediate space 86 and sandwiched between the top plate 82 and the bottom plate 84. In the first embodiment, the hang-off system 16 comprises exactly three load cells 88. Each part 76 comprises exactly one load cell 88 arranged in the intermediate space 86. Preferably, the load cells 88 are regularly spaced around the first axis A1. Using three load cells 88 is advantageous since they provide a stable support for the top plates 82. The leveling of the load cells 88 is also easier. However, in a variant, each part 76 comprises several load cells 88, for example a number of load cells 88 comprised between 2 and 5. In any case, the loads cells 88 are leveled to each other.

Each load cell 88 is configured to sense a parameter representative of an axial load applied between the top plate 82 and the bottom plate 84. Each load cell 88 is configured to convert a load applied between the top plate 82 and the bottom plate 84 into a corresponding electrical signal sent to the data acquisition system 68. For example, each load cell 88 comprises at least one load sensor, preferably a plurality of load sensors for redundancy. For example, each load cell 88 is a vibrating wire load cell comprising at least one vibrating wire sensor, preferably a plurality of vibrating wire sensors. In a variant, the load cell 88 is a strain gauge load cell, a pneumatic load cell, a capacitive load cell, a hydraulic load cell or a piezoelectric load cell.

Each load cell 88 rests against the bottom surface 96 of top plate 82 and against the top surface 112 of the bottom plate 84. Each load cell 88 extends according to an axis substantially parallel to the first axis A1. Advantageously, the bottom surface 96 of the top plate 82 and/or the top surface 112 of the bottom plate 84 define a convex surface 123 (FIG. 2) protruding towards the intermediate space 86 and in contact with the load cell 88. This allow to ensure a good contact between the load cell 88 and the top plate 82/bottom plate 84 and reduce additional measurement uncertainties that a flat-to-flat contact may induce.

Advantageously, at least one part 76 of the annular collar 66 may comprise at least one shim 124, schematically shown in FIG. 2, arranged between the top surface 112 of the bottom plate 84 and the load cell 88 to compensate machining tolerance which can generate a difference between the heights of the load cells 88 and affect the data reliability. During the onshore assembly of the part 76, if required, the operator easily compensates the height difference of each load cell 88 by using a circular shim of a thickness comprised between 0.1 mm and 0.3 mm for example. In other words, the shims allow leveling the load cells 88 between each other.

Each load cell 88 is connected to the data acquisition system 68 to monitor the time variations of the parameter representative of the load applied between the top plate 82 and the bottom plate 84 of each part 76 of the annular collar 66. The data acquisition system 68 may comprise a memory to record the values of the parameter representative of the load applied between the top plate 82 and the bottom plate 84, and/or a display device (not shown) to display the values of the parameter.

Advantageously, each part 76 of the annular collar 66 comprises at least a first reinforcement element 126 protruding from the top plate 82 towards the intermediate space 86, and a second reinforcement element 128 protruding from the bottom plate 84 towards the intermediate space 86. The first reinforcement element 126 is arranged facing the second reinforcement element 128 along a direction substantially parallel to the first axis A1. When the hang-off system 16 is assembled, the first reinforcement element 126 and the second reinforcement element 128 are separated by a gap comprised between 5 mm and 10 mm.

The reinforcement elements 126, 128 are conservative features to avoid operational problems caused by an unexpected and unpredicted abnormal load. They act as a support and do not allow vertical deflection, improving the structural resistance of the hang-off system 16 in case a load cell 88 structurally fails. The reinforcement elements 126, 128 allow not depending on the load cell 88 integrity to ensure operational continuity and the correct functioning of the hang-off system 16.

Preferably, each part 76 comprises a plurality of first reinforcement elements 126 and a plurality of second reinforcement elements 128 arranged around the first axis A1.

For example, at least a part of the first reinforcement element 126 may be formed by the lower assembling portions 102 of the top plate 82. At least a part of the second reinforcement elements 128 may be formed by the upper assembling portions 116, 118 of the bottom plate 84.

A method 400 for assembling a top-end fitting 26 of a flexible pipe 12 on a surface assembly 14 with a hang-off system 16 as described above is now described in reference to FIG. 5.

The method 400 comprises a preparation step 410 preferably performed onshore. During this step 400, each part 76 of the annular collar 66 is assembled independently from each other. In particular, for each part 76 of the annular collar 66, the top plate 82 and the bottom plate 74 are assembled to each other without torque using the fasteners 120 and the locknuts 122. The at least one load cell 88 is arranged in the intermediate space 86. In the first embodiment, three independent assembled parts 76 are obtained.

Advantageously, the preparation step 410 comprises a factory acceptance test and/or a site acceptance test and/or a calibration test 420. In particular, preferably, the preparation test 410 comprises pre-assembling 430 the parts 76 of the annular collar 66 to each other before performing the factory acceptance test and/or the site acceptance test and/or the calibration test 420, and disassembling 440 the parts 76 from each other after the factory acceptance test and/or the site acceptance test and/or the calibration test are completed.

The hang-off system 16 may now be assembled to the end fitting 26 offshore during an assembling step 450. During this step 450, the annular collar 66 is formed by assembling the parts 76 to each other around the end fitting 26 and by assembling the parts to the surface assembly 14 via the top surface 64 of the support 58. For example, each part 76 is moved using a hoisting device.

The assembling method 400 is very advantageous since each part 76 of the annular collar 66 is independently pre-assembled, tested and calibrated, preferably onshore. The offshore installation is easier since it only requires assembling the parts 76 between each other. The method 400 ensures traceability a low risk of losing parts.

A second embodiment is now described in reference to FIG. 6. This embodiment is described by differences with respect to the first embodiment.

In this embodiment, the annular collar 66 is formed by exactly two parts 76 assembled to each other. Each part 76 of the annular collar 66 extends along a circular arc in a plane substantially perpendicular to the first axis A1 between a first end 78 and a second end 80, around the end fitting 26. In the second embodiment, the circular arc has an angle substantially equal to 180°. In the second embodiment, the hang-off system 16 comprises exactly three load cells 88, preferably regularly spaced around the first axis A1. A first part 130 among the two parts 76 comprises one load cell 88 and a second part 132 among the two parts 76 comprises two load cells 88.

The assembling method 400 described above is similar for this embodiment.

In a variant of the first embodiment and of the second embodiment, the assembly 10 may comprise an apparatus (not shown) for inspecting and monitoring the internal structures of the flexible pipe, specifically the armor layers 36, 38 of the flexible pipe body 24. The apparatus comprises optical sensors, such as strain gauges based on Fiber Bragg Grating (FBG) technology attached to each wire of the outer armor layer. The strain measurements provided by these sensors make it possible to identify broken wires and detect events associated with wire ruptures. Santiago et al, in “Monitoring Flexible Risers with Optical Sensors—Operational Experience and Future Perspectives”, Offshore Technology Conference, 2017, WO 2014/161056 A1 and EP 2 489 824 A2 disclose an example of such kind of apparatus called MODA (for “Monitoring based on Optical fiber attached Directly on Armor wires”) and developed by the company Petrobras.

Alternatively, the optical sensors are fiber-optic sensors placed between the metallic wires of one or both of the armor layers 36, 38. In a variant, the fiber-optic sensors can replace one or more of the metallic wires of one or both of the armor layers 36, 38. In another variant, the fiber-optic sensors can be attached directly to the flexible pipe body 24. Preferably, but not necessarily, the fiber-optic sensor can be enclosed within or armored by a metal tube. The fiber is then called Fiber In Metal Tube (FIMT).

The fiber-optic sensors can be used in Distributed Fiber Optic Sensing Techniques (DFOS) like Distributed Acoustic Sensing (DAS) and/or Distributed Temperature Sensing (DTS) techniques, to detect and measure for example variation of the temperature and/or of the pressure and/or of the gas/fluid composition within the annular space of the flexible pipe 12. Also, the integrity of the metallic tensile wires of the armor layers 36, 38 can be monitored to detect potential crack initiations or sudden breakages.

Advantageously, in this variant of the first and second embodiments of the invention, the load cells 88 of the hang-off system 16 according to the invention are fiber optic load cells. The data acquisition system 68 is then connected to both the loads cells 88 of the hand-off system 16 and the optical sensors of the apparatus for inspecting and monitoring the internal structures of the flexible pipe 12. This is particularly advantageous since only one single data acquisition system 68 is used to record both kind of measurements.

In that respect, the measurements obtained with the hang-off system 16 according to the invention may be used to calibrate the measurements obtained with the apparatus for inspecting and monitoring the internal structures of the flexible pipe 12. Moreover, both kind of measurements may be used in modeling software to assess the integrity of the end fitting 26 and of the flexible pipe 12.

In another variant of the first embodiment and of the second embodiment, the assembly 10 and more especially the hang-off system 16 may comprise an apparatus (not shown) for inspecting and monitoring the internal structures of the flexible pipe, specifically the armor layers 36, 38 of the flexible pipe body 24. The apparatus comprises a visual system such as a video camera, or magnetic sensors to detect sudden breakage of the metallic wires leading to a disorganization of the flexible pipe structure. This phenomenon causing the torsion of the flexible pipe structure is called “pig-tail”. The Brazilian patent application PI 0601923-4 A and the document OTC-18946 “Surface Monitoring Techniques for a Continuous Flexible Riser Integrity Assessment”, Offshore Technology Conference, May 2007, disclose an example of such kind of apparatus.

1. A hang-off system for measuring a top tension in a flexible pipe, said flexible pipe comprising a flexible pipe body and a top end-fitting arranged at an end of the flexible pipe body, the hang-off system being intended to maintain the top end-fitting on a surface assembly, the hang-off system comprising:
an annular collar extending along a first axis (A1), the annular collar being intended to be arranged around the top end-fitting, the annular collar being formed by at least two parts assembled to each other, each part comprising a top plate and a bottom plate assembled to each other, said top plate and bottom plate delimiting an intermediate space between them, at least one part comprising at least one load cell arranged in the intermediate space and sandwiched between the top plate and the bottom plate, the bottom plate being intended to be assembled on the surface assembly,
a data acquisition system connected to the load cell.

2. The system of claim 1, wherein each part comprises at least one load cell, the load cells of the hang-off system being regularly spaced around the first axis (A1).

3. The system according to claim 1, wherein the top plate mainly extends in a first plane and the bottom plate mainly extends in a second plane substantially parallel to the first plane and perpendicular to the first axis (A1).

4. The system according to claim 1, wherein the annular collar is formed by exactly two parts or exactly three parts assembled to each other.

5. The system according to claim 4, wherein the annular collar is formed by exactly three parts assembled to each other, each part comprising a single load cell sandwiched between the top plate and the bottom plate of said part.

6. The system according to claim 1, wherein each part comprises a plurality of fasteners and locknuts for assembling the top plate to the bottom plate, each fastener extending along an axis substantially parallel to the first axis (A1).

7. The system according to claim 1, wherein the top plate and/or the bottom plate define a convex surface protruding towards the intermediate space, said convex surface being in contact with the load cell.

8. The system according to claim 1, wherein each bottom plate and each top plate of each part of the annular collar extends respectively along a circular arc in a plane substantially perpendicular to the first axis (A1) between a first end and a second end, each first end and second end comprising at least an assembling portion, the at least two parts of the annular collar being assembled to each other by said assembling portions.

9. The system according to claim 1, wherein at least one part of the annular collar comprises at least one shim arranged between the bottom plate and the load cell.

10. The system according to claim 1, wherein each part of the annular collar comprises at least a first reinforcement element protruding from the top plate towards the intermediate space, and a second reinforcement element protruding from the bottom plate towards the intermediate space, the first reinforcement element being arranged facing the second reinforcement element along a direction substantially parallel to the first axis (A1), the first reinforcement element and the second reinforcement element being separated by a gap comprised between 5 mm and 10 mm.

11. An assembly comprising:
a flexible pipe comprising a top end-fitting,
a surface assembly,
a hang-off system according to claim 1, the hang-off system maintaining the top end-fitting on the surface assembly.

12. A method for assembling a top end-fitting of a flexible pipe on a surface assembly with a hang-off system according to claim 1, said method comprising the following steps:
a preparation step comprising, for each part of the annular collar, assembling the top plate to the bottom plate and arranging at least one load cell in the intermediate space of one of the parts,
an assembling step comprising forming the annular collar by assembling the parts to each other around the end fitting and by assembling the parts to the surface assembly.

13. The method according to claim 12, wherein the preparation step is performed onshore and the assembling step is performed offshore.

14. The method according to claim 12, wherein the preparation step comprises a factory acceptance test and/or a site acceptance test and/or a calibration test.

15. The method according to claim 14, wherein the preparation test comprises pre-assembling the parts of the annular collar to each other before performing the factory acceptance test and/or the site acceptance test and/or the calibration test, and disassembling the parts from each other after the factory acceptance test and/or the site acceptance test and/or the calibration test are completed.
